(19) United States
(12) Patent Application Publication
(10) Pub. No.: US 2021/0309546 A1
(43) Pub. Date: Oct. 7, 2021

(54) APPARATUS AND METHOD FOR PREPARING HYDROGEN WATER

(71) Applicant: Jiangsu Boer Technology Co., Ltd., Nanjing (CN)

(72) Inventor: JIAN YANG, Nanjing (CN)

(21) Appl. No.: 17/346,172

(22) Filed: Jun. 11, 2021

Related U.S. Application Data
(63) Continuation of application No. PCT/CN2019/124864, filed on Dec. 12, 2019.

(30) Foreign Application Priority Data
Jan. 31, 2019 (CN) 201910097805.5

(51) Int. Cl. C02F 1/68

(52) U.S. Cl. CPC C02F 1/685; C02F 2301/066; C02F 2209/30

(57) ABSTRACT

An apparatus and a method for preparing hydrogen water. The apparatus includes a pressure tank, a membrane-type liner, a pressure tank cover and a multifunctional water processor. The membrane-type liner is made of a functional polymer composite, and the membrane-type liner, the pressure tank cover and the multifunctional water processor are detachably arranged in the pressure tank. Two cavities are formed by the sealed connection of the pressure tank, the membrane-type liner and the pressure tank. An interior of the membrane-type liner forms a first cavity, and a second cavity is formed between an inner wall of the pressure tank and an outer wall of the membrane-type liner. The functional hydrogen gas stored in the second cavity diffuses into the membrane-type liner, and gradually penetrates into the active water in the first cavity to form the hydrogen water.

### CROSS-REFERENCE TO RELATED APPLICATIONS

This application is a continuation of International Patent Application PCT/CN2019/124864, filed on Dec. 12, 2019, which claims the benefit of priority from Chinese patent applications No. 201811527902.5 and No. 201910097805.5, respectively filed on Dec. 13, 2018 and Jan. 31, 2019. The content of the aforementioned application, including any intervening amendments thereto, is incorporated herein by reference.

### TECHNICAL FIELD

The present application relates to hydrogen water treatment, and more particularly to an apparatus and a method for preparing hydrogen water.

### BACKGROUND OF THE INVENTION

Health is the eternal pursuit of mankind. Nowadays, the medical development strategy should be changed from “curing of diseases” into “prevention of diseases and injuries and maintaining and promotion of health”.

Water is essential for human life and health. With the general improvement of living standards and awareness of medical care, the requirements of water quality have been increased from “safety” to “healthy”. High-quality healthy drinking water, as a basic demand for people's daily life, has become the development trend of the drinking water.

In recent years, extensive researches have been conducted on the medical and biological effects of hydrogen molecule, and the leading countries and well-known research institutions in the biomedical field have actively participated in the exploration and research in this related field. The hydrogen has been widely recognized at home and abroad for use in human body. Many countries, such as China, Japan, the European Union, and the United States, have approved the use of hydrogen as a food additive (China National Standard GB31633-2014 Food Safety National Standard, Food Additive, Hydrogen). The hydrogen molecule is currently accepted as the smallest molecule in the universe, which can enter the skin, mucous membranes, bones, blood-brain barrier, and other human organs, tissues, cells, and intracellular structures including mitochondria and cell nuclei through diffusion. How to promote and maintain health is a proposition that humans have been exploring for thousands of years. With the rapid economic and social development, and the transformation of people's lifestyles, there is a growing demand for consumption about health promotion. In view of the selective anti-oxidation activity, anti-inflammatory activity and malignant free radical scavenging activity of hydrogen molecule, hydrogen water has been developed and gradually becomes commercially available, which is well appreciated by consumers. Hydrogen water can be used as energy supplement for human body. Moreover, hydrogen molecule can scavenge excess malignant free radicals in the human body, including hydroxyl free radicals and nitrate anions, and its selective antioxidant and anti-inflammatory activities make it beneficial to disease prevention and treatment, anti-cell mutation, anti-apoptosis, beauty maintenance, anti-aging, health promotion, and so on.

The content of hydrogen molecules in hydrogen water is commonly represented by mass percentage concentration (PPM). In general, the saturation concentration of hydrogen molecules in water is about 1.6 PPM, and the hydrogen water with a concentration of hydrogen molecules greater than 1.6 PPM is regarded as the supersaturated hydrogen water. Generally, only when the hydrogen molecule concentration is more than 1.0 PPM, the hydrogen water exhibits significant medical and biological effects. At present, the concentration of hydrogen molecules in most products on the market, such as hydrogen-rich water sticks, hydrogen-rich water cups, and water electrolyzers, most bottled and bagged hydrogen-rich water, is less than 1.0 PPM.

A hydrogen water preparation apparatus commonly includes a hydrogen generator or a hydrogen storage container to supply hydrogen, which is then dissolved in water to produce the hydrogen water. For instance, Chinese Patent Application No. 201620542931.9 discloses a hydrogen-rich water drinking machine by extracting water from the air, in which the drinking water stored in the water storage device is electrolyzed through a hydrogen generator so that the drinking water contains hydrogen. However, the hydrogen generation may also be accompanied by the production of chemical by-products during the electrolysis process, leading to low content and poor purity. Chinese Patent Application No. 201820387846.9 discloses a hydrogen-rich water filter-type generator for intestinal hydrotherapy, including a reaction tank, a support frame, a drainage sealing plate, an air pressure mechanism, a reaction mechanism and a control device. The drainage sealing plate is arranged at the left side of the longitudinal center line of the reaction tank to divide the interior of the reaction tank into a water storage chamber and a reaction chamber; several diversion holes are formed on the drainage sealing plate; the reaction mechanism is arranged in the reaction chamber through the support frame, and is fixedly connected with the drainage sealing plate, so that the reaction mechanism communicates with the water storage chamber through the diversion holes; the air pressure mechanism is arranged on one end of the reaction tank provided with the reaction chamber, and is connected with the reaction mechanism; a water outlet and a air outlet are respectively arranged on the bottom and the top of the water storage chamber; and the air pressure mechanism and the reaction mechanism are both electrically connected with the control device. Chinese Patent Application No. 201810931353.1 provides a hydrogen-rich water generator equipped with a stirrer, including a first water tank, a first water delivery pipe, a second water delivery pipe, a first water pump, a second water tank, a hydrogen generator equipped with a hydrogen outlet pipe, and a liquid mixing pipe, where the first water pump is connected to the second water tank through the second water delivery pipe, and the second water tank is provided with a third water delivery pipe; the liquid mixing pipe is provided with a self-priming booster pump, and the outlet of the self-priming booster pump is connected to the stirrer through a connecting pipe; a water pipe and a gas-liquid mixing pipe are arranged in the stirrer, and an impeller is arranged in the gas-liquid mixing pipe; the hydrogen discharged from the hydrogen outlet pipe and the water in the third water delivery pipe enter into the gas-liquid mixing pipe under the action of the self-priming booster pump, and then the hydrogen-water mixture flows into the stirrer through the connecting pipe. The pressure of hydrogen and water in the water pipe gradually increases, which makes the flow rate become faster, such that the hydrogen is dissolved in water under the action of the impeller in the gas-liquid mixing pipe to form the hydrogen-rich water. The above device for generating hydrogen water has complicated structure, cumbersome operations, and high cost. Moreover, even if the hydrogen is directly dissolved in water by high pressure, the hydrogen molecules will easily escape after being released. Chinese Patent Application No. 201710082924.4 discloses a hydrogen-rich water drinking machine, where a hydrogen-generating material is used, which can undergo chemical reactions to produce the hydrogen-rich water. However, the above chemical reaction process is often accompanied by the occurrence of by-products, and the prepared hydrogen-rich water has a low concentration and poor stability.

### SUMMARY

An object of this disclosure is to provide an apparatus and a method for efficiently preparing hydrogen water to overcome the above-mentioned deficiencies in the prior art, where the hydrogen concentration can reach 3.0 ppm or more, and the apparatus in this disclosure has simple structure, convenient operation, desirable performance, low energy consumption, high safety and reliability, low cost and good reusability.

Technical solutions of this disclosure are described as follows.

In a first aspect, this application provides an apparatus for preparing hydrogen water, comprising:

a pressure tank;

a membrane-type liner;

a pressure tank cover; and

a multifunctional water processor;

wherein the membrane-type liner is made of a functional polymer composite; the membrane-type liner and the multifunctional water processor are detachably arranged in the pressure tank; the pressure tank cover is detachably arranged on the pressure tank; the pressure tank, the membrane-type liner and the pressure tank cover are sealedly connected to form two cavities; the membrane-type liner is configured to be a first cavity for storing water treated by the multifunctional water processor; a second cavity is formed between an inner wall of the pressure tank and an outer wall of the membrane-type liner for storing hydrogen gas.

The membrane-type liner in the apparatus provided herein has good permeability and elasticity, so that the functional hydrogen gas molecules can diffuse into the first cavity to be dissolved in the active water in the first cavity to form the hydrogen-rich water. The obtained hydrogen water has high hydrogen molecule content (more than 3.0 ppm) and desirable stability.

In some embodiments, the membrane-type liner has a permeability of 2˜1000 barrer (1 barrer=10⁻¹⁰ cm³(STP)·cm·s⁻¹·cm⁻²·cmHg⁻¹), preferably 2˜300 barrer, and more preferably 2˜100 barrer; and the functional polymer composite is rubber or thermoplastic elastomer. In an embodiment, the functional polymer composite is selected from the group consisting of polysulfone, cis-butadiene rubber, silicone rubber, silica gel, polyimide and a combination thereof.

In an embodiment, a pressure of the hydrogen gas in the second cavity is 0.01-2 MPa, preferably 0.05-1 MPa.

It has been found that the functional hydrogen gas molecules stored in a rubber membrane-type liner will gradually decrease, and the internal pressure will become lower and lower as the storage time extends. Based on the above-mentioned characteristics of a functional polymer material, the functional hydrogen molecules are stored at one side of the functional polymer membrane, and the purified water is stored at the other side. Based on this arrangement, the hydrogen gas molecules will gradually penetrate into the water to form a stable hydrogen-in-water structure, forming the hydrogen water with hydrogen molecules gathered. The above process naturally occurs, and does not require energy consumption and complex electrochemical reactions, allowing for high efficiency and low energy consumption. The permeability and elasticity of the functional polymer membrane are the key factors to realize the efficient preparation of hydrogen water. If the permeability of the membrane material is too low, the preparation time will be extended, thus reducing its practicability. At the same time, the elastic function enables that the pore structure of the functional polymer composite membrane can be altered through changing the pressure difference, realizing the intelligent opening and closing. When the pressure difference is large, the expansion of the pore structure is beneficial to significantly increase the permeability and the diffusion coefficient of hydrogen molecules; when the pressure difference is low, the shrinkage of the pore structure is beneficial to improve the utilization of hydrogen molecules.

It has also been found that the magnetic resonance can further enhance the permeability and dissolving ability of the purified water, and makes the water less prone to freezing even at a sub-zero temperature. The half-width of the above-mentioned water is measured by 17O-nuclear magnetic resonance spectroscopy (ONMR) to be less than 100 Hz, which shows that activated water is beneficial to improve the solubility of hydrogen molecules, and the formed hydrogen-in-water structure is relatively stable, providing a relevant synergistic effect for the efficient preparation of hydrogen water.

In some embodiments, the pressure tank cover is provided with a water port for feeding and discharge of water; the pressure tank is provided with an air hole for feeding and discharge of air; and a handle is arranged on the pressure tank cover or the pressure tank.

In some embodiments, a fastener is arranged on the pressure tank; the pressure tank is sealedly connected with the pressure tank cover through the fastener; or the pressure tank is threadedly connected with the pressure tank cover.

In some embodiments, a quick-plug assembly is provided at the water port of the pressure tank cover; the quick-plug assembly comprises a female plug and a male plug; one end of the female plug is sealedly connected with the water port on the pressure tank cover, and the other end of the female plug is sealedly connected with the male plug by plugging. The quick-plug assembly can be connected with faucet tap for direct portable uses, and can also be connected with various drinking water equipment or water supply equipment for combined uses, which can realize the integration of utilization, storage and preparation of hydrogen water. In an embodiment, the water port is provided with a threaded joint; one end of the threaded joint is sealedly connected with the water port on the pressure tank cover, and the other end of the threaded joint is sealedly connected with a drinking water equipment or a water supplying equipment by screwing.

In an embodiment, a surface of the membrane-type liner sealedly connected with the pressure tank cover is provided with an upper convex ring; a surface of the pressure tank cover in contact with the upper convex ring is provided with an upper annular groove matching with the upper convex ring; and a surface of the membrane-type liner sealedly connected with the pressure tank is provided with a lower convex ring; a surface of the pressure tank in contact with the lower convex ring is provided with a lower annular groove matching with the lower convex ring.

In some embodiments, the multifunctional water processor comprises at least one chamber arranged in series; each of the at least one chamber is provided with a replaceable functional core; the functional core in at least one of the at least one chamber is made of a magnetic material; the at least one chamber is sealedly connected through a thread connection or a quick-plug joint; and the at least one chamber is in communication with each other. In some embodiments, the at least one chamber consists of a first chamber and a second chamber; the functional core arranged in the first chamber is selected from the group consisting of activated carbon, activated carbon rod, activated carbon fiber, silver-loaded activated carbon fiber, electrocrystalline film, graphene, maifanite, tourmaline, activated alumina, KDF (Kinetic Degradation Fluxion) filter, PP cotton, a non-woven material and a combination thereof, preferably selected from the group consisting of activated carbon, activated carbon fiber, silver-loaded activated carbon fiber, electrocrystalline film, graphene, maifanite, KDF filer, a non-woven material and a combination thereof. The functional core arranged in the second chamber is at least one group of a magnetic material component, which is detachably assembled. In an embodiment, the number of the at least one group of the magnetic material component is two or more.

In some embodiments, an upper water port of the multifunctional water processor is arranged on the first chamber, and is sealedly connected with the water port of the pressure tank cover by threaded or quick-plug connection. A lower water port of the multifunctional water processor is arranged below the second chamber. In an embodiment, a water hole is arranged on the surface of the chamber. The chamber can be used individually, or multiple chambers are sealedly connected for combined use.

In some embodiments, the pressure tank, the pressure tank cover, the fastener, the quick-plug assembly, the threaded joint and the multifunctional water processor are made of a metal material or an organic composite material with a certain pressure strength, preferably a food grade or medical grade stainless steel material.

In a second aspect, this disclosure provides a method for efficiently preparing hydrogen water by using the above apparatus, comprising:

feeding purified water to the multifunctional water processor; allowing water treated by the multifunctional water processor to flow into the first cavity of the pressure tank;

feeding hydrogen gas to the second cavity;

diffusing the hydrogen gas stored in the second cavity into the membrane-type liner followed by penetration into the water in the first cavity to form a hydrogen-in-water structure to produce the hydrogen water; and

opening a water outlet to obtain the hydrogen water, wherein the hydrogen water in the first cavity is driven under a pressure of the hydrogen gas in the second cavity to automatically flow out.

In an embodiment, the method comprises:

(1) purifying water in advance to obtain the purified water;

(2) evacuating air in the pressure tank by vacuuming or by hydrogen purging;

(3) processing the purified water with the multifunctional water processor; and allowing water processed by the multifunctional water processor to enter the first cavity of the pressure tank for storing;

(4) feeding the hydrogen gas into the second cavity of the pressure tank for storing, and increasing a pressure in the second cavity to 0.01-2 MPa, preferably 0.05-1 MPa ;

(5) diffusing the hydrogen gas stored in the second cavity into the membrane-type liner followed by penetration into the water in the first cavity; and

(6) subjecting the pressure tank to standing, and adjusting the pressure in the second cavity of the pressure tank to a range for normal use of hydrogen water, preferably 0.01-0.5 MPa.

In an embodiment, an order of step (3) and step (4) is exchanged, as shown below:

(3) feeding the hydrogen gas into the second cavity of the pressure tank for storing, and increasing the pressure in the second cavity to 0.01-2 MPa, preferably 0.05-1 MPa;

(4) processing the purified water with the multifunctional water processor; and allowing water processed by the multifunctional water processor to enter into the first cavity of the pressure tank for storing.

In some embodiments, in step (5), the diffusion of the hydrogen gas into the membrane-type liner is performed by ultrasonic vibration for 0.1-10 h, preferably 0.5-5 h, on an ultrasonic vibrator, which facilitates the complete mixing of the hydrogen gas and water to form a stable hydrogen-in-water structure.

The beneficial effects of this disclosure are described below.

1. In the apparatus provided herein, through the provision of a membrane-type liner with good permeability and elasticity, the functional hydrogen gas molecules can gradually diffuse into the activated water in the membrane-type liner to form a stable hydrogen-in-water structure, forming highly-effective hydrogen water with a concentration of hydrogen molecules more than 3.0 ppm.

2. The hydrogen water prepared herein has a high concentration of hydrogen molecules and a stable structure. Moreover, the whole preparation is completed by a physical process, and does not involve complex chemical reactions and chemical by-products, facilitating achieving the highly-efficient, energy-saving, safe, and environmentally-friendly production.

3. With respect to the multifunctional water processor used herein, the core can be replaced according to the actual requirement, and based on functions of the functional cores such as filtration, adsorption, mineralization, purification, interaction, activation, magnetic effect and energy storage, the water can be further purified, sterilized, improved in the mouth feel and enhanced in the energy storage. Furthermore, after undergoing the magnetic resonance, the activated water has enhanced permeability and dissolving ability, which is beneficial to improve the solubility and stability of hydrogen molecules.

4. Through the multifunctional design, the pressure tank can be connected with faucet tap by fast-inserting connection for direct and movable use, and can also be connected with various drinking water equipment or water supply equipment by fast-inserting connection or threaded connection for use, facilitating the integration of utilization, storage and hydrogen water preparation of hydrogen water.

5. The apparatus has a simple structure, convenient operations, diverse functions, remarkable performance, low cost, and good reusability.

### BRIEF DESCRIPTION OF THE DRAWINGS

FIG. 1 schematically shows a structure of a hydrogen water preparation apparatus according to an embodiment of the disclosure;

FIG. 2 is an enlarged view of part A in FIG. 1;

FIG. 3 schematically shows a structure of a quick-plug assembly according to an embodiment of the disclosure;

FIG. 4 schematically shows a structure of a threaded joint of the water port on the pressure tank cover according to an embodiment of the disclosure; and

FIG. 5 schematically depicts a structure of a multifunctional water processor according to an embodiment of the disclosure.

In the drawings: 1, pressure tank; 2, membrane-type liner; 3, pressure tank cover; 4, first water port 5, first cavity; 6, second cavity; 7, air hole; 8, fastener; 9, quick-plug assembly; 10, upper convex ring; 11, lower convex ring; 12, upper annular groove; 13, lower annular groove; 14, handle; 91, female plug; 92, male plug; 101, threaded joint; 15, second water port; 16, first chamber; 17, second chamber; 18, water hole; 19, first functional core; 20, second functional core; 21, upper connection port; 22, lower connection port; 23, upper water port; 24, lower water port; and 25, multifunctional water processor.

### DETAILED DESCRIPTION OF EMBODIMENTS

To render the technical solutions of the present disclosure clearer, the disclosure will be described in detail below with reference to the drawings and embodiments. It is apparent that the embodiments provided below are merely some embodiments of the disclosure and are not intended to limit the disclosure.

### Embodiment 1

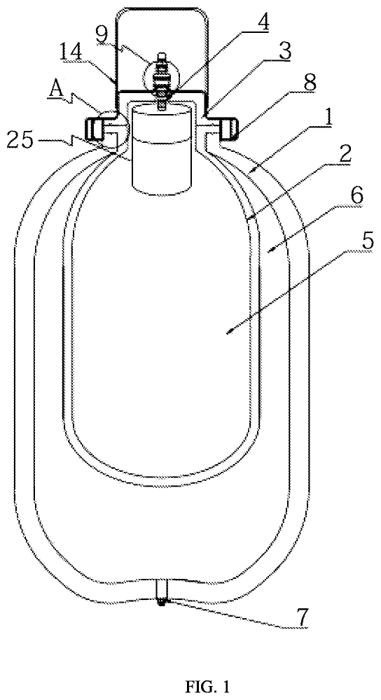

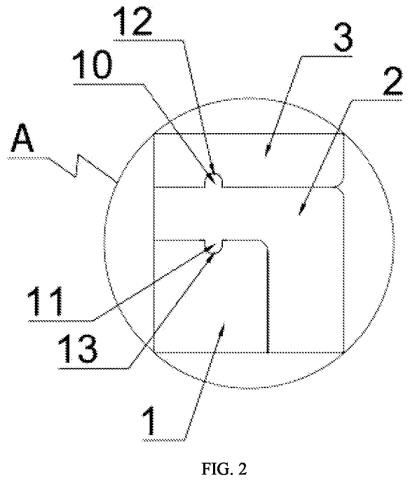

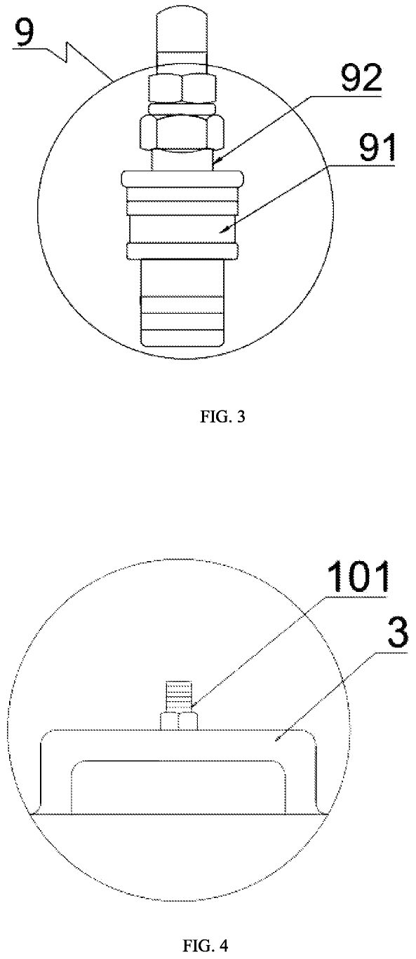

As shown in FIGS. 1-3, an apparatus for preparing hydrogen water includes a pressure tank 1 made of stainless steel, an membrane-type liner 2 arranged in the pressure tank 1 and a pressure tank cover 3 made of stainless steel. An interior of the membrane-type liner forms a first cavity 5, and a second cavity 6 is formed between an inner wall of the pressure tank 1 and an outer wall of the membrane-type liner 2. The membrane-type liner 2 is made of an organic silicone-rubber composite. The pressure tank cover 3 is provided with a first water port 4 for feeding and discharge of water. A bottom of the pressure tank 1 is provided with an air hole 7. The pressure tank 1 is provided with a fastener 8, and the pressure tank 1 is sealedly connected with the pressure tank cover 3 through the fastener 8, so that the pressure tank cover 3 can be disassembled quickly, facilitating the cleaning and disinfection of the membrane-type liner 2. An upper convex ring 10 is arranged on an upper surface of an outer wall of an opening of the membrane-type liner 2, and a surface of the pressure tank cover 3 contacting with the upper convex ring 10 is provided with an upper annular groove 12 matching with the upper convex ring 10. A lower convex ring 11 is arranged on a lower surface of the outer wall of the opening of the membrane-type liner 2, which matches with a lower annular groove 13 arranged on the opening of the pressure tank 1, such that the pressure tank cover 3 is just arranged above the upper convex ring 10 for sealed connection. The first water port 4 of the pressure tank cover 3 is provided with a quick-plug assembly 9 made of stainless steel, including a female plug 91 and a male plug 92, where the female plug 91 is sealedly connected with the male plug 92 by plugging, which can isolate the air, so that the hydrogen water will not be exposed to the air during the process of inflow and outflow, preventing secondary pollution and keeping the stored hydrogen water in a fresh state for a long time. Furthermore, the quick-plug assembly 9 can be quickly connected with various drinking water equipment or water supply equipment to realize the integration of utilization, storage and preparation of hydrogen water. In an embodiment shown in FIG. 4, a threaded joint 101 is provided at the first water port 4, where one end of the threaded joint 101 is sealedly connected with the first water port 4 on the pressure tank cover 3, and the other end of the threaded joint 101 is sealedly connected with various drinking water equipment or water supplying equipment by screwing.

The purified water is injected into the first cavity 5 (namely an interior of the membrane-type liner 2 made of silicone rubber with a permeability of 289 barrer; 1 barrer=10⁻¹⁰·cm³ (STP) cm·s⁻¹·cm⁻²·cm Hg⁻¹) through the first water port 4.

Since the polymer composite has good elasticity, the pore structure thereon can be stretched by increasing the pressure. Ultra pure hydrogen gas (purity: 99.999%) with a pressure of 0.3 MPa is fed into the second cavity 6 through the air hole 7 for storage (for about 3-month use; the hydrogen gas can be repeatedly fed when it is insufficient). The hydrogen gas stored in the second cavity 6 can be diffused into the membrane-type liner 2 for 2 hours, and then gradually penetrates into the water in the first cavity 5. Meanwhile, the pressure tank 1 is placed on an ultrasonic oscillator to accelerate the diffusion of hydrogen molecules and enable the hydrogen molecules and water to be fully mixed. Then the pressure tank 1 is subjected to standing for 0.5 h to form a stable hydrogen-in-water structure to obtain hydrogen water with a hydrogen molecule concentration of 2.3 ppm. When the first water port 4 is opened, the hydrogen water in the first cavity 5 is driven by the gas pressure in the second cavity 6 to be automatically discharged.

### Embodiment 2

An apparatus and a method for preparing hydrogen water are provided herein. The apparatus includes a pressure tank 1 made of stainless steel, a membrane-type liner 2 arranged in the pressure tank 1 and a pressure tank cover 3 made of stainless steel. An interior of the membrane-type liner forms a first cavity 5, and a second cavity 6 is formed between an inner wall of the pressure tank 1 and an outer wall of the membrane-type liner 2. The membrane-type liner 2 is made of a polysulfone composite. The pressure tank cover 3 is provided with a first water port 4. A bottom of the pressure tank 1 is provided with an air hole 7. The pressure tank 1 is sealedly connected with the pressure tank cover 3 through threaded connection, so that the pressure tank cover 3 can be disassembled quickly, facilitating the cleaning and disinfection of the membrane-type liner 2. An upper convex ring 10 is arranged on an upper surface of the outer wall of an opening of the membrane-type liner 2, and a surface of the pressure tank cover 3 contacting with the upper convex ring 10 is provided with an upper annular groove 12 matching with the upper convex ring 10. A lower convex ring 11 is arranged on a lower surface of the outer wall of the opening of the membrane-type liner 2, which matches with a lower annular groove 13 arranged on the opening of the pressure tank 1, such that the pressure tank cover 3 is just arranged above the upper convex ring 10 for sealed connection. The first water port 4 of the pressure tank cover 4 is provided with a quick-plug assembly 9 made of stainless steel, including a female plug 91 and a male plug 92, where the female plug 91 is sealedly connected with the male plug 92 by plugging, which can isolate the air, so that the hydrogen water will not be exposed to the air during the process of inflow and outflow, preventing secondary pollution, and keeping the stored hydrogen water in a fresh state for a long time. Furthermore, the quick-plug assembly 9 can be quickly connected with various drinking water equipment or water supply equipment to realize the integration of utilization, storage and preparation of hydrogen water.

The purified water is injected into the first cavity 5 (namely an interior of the membrane-type liner 2 made of the polysulfone composite with a permeability of 51.5 barrer) through the first water port 4. Since the polymer composite has good elasticity, the pore structure thereof can be stretched by increasing the pressure. Ultra pure hydrogen (purity: 99.999%) with a pressure of 1.0 MPa is fed into the second cavity 6 through the air hole 7 for storage (for about 3-month use; the hydrogen gas can be repeatedly fed when it is insufficient). The hydrogen gas stored in the second cavity 6 can be diffused into the membrane-type liner 2 for 4 hours, and then gradually penetrates into the water in the first cavity 5. Meanwhile, the pressure tank 1 is placed on an ultrasonic oscillator to accelerate the diffusion of hydrogen molecules and enable the hydrogen molecules and water to be fully mixed. Then the pressure tank 1 is subjected to standing for 0.5 h to form a stable hydrogen-in-water structure to produce hydrogen water with a hydrogen molecule concentration of 3.0 ppm, and then the pressure in the second cavity 6 of the pressure tank 1 is adjusted to 0.1-0.35 MPa in a static state for normal use of the hydrogen water. When the first water port 4 is opened, the hydrogen water in the first cavity 5 is driven by the gas pressure in the second cavity 6 to be automatically discharged.

### Embodiment 3

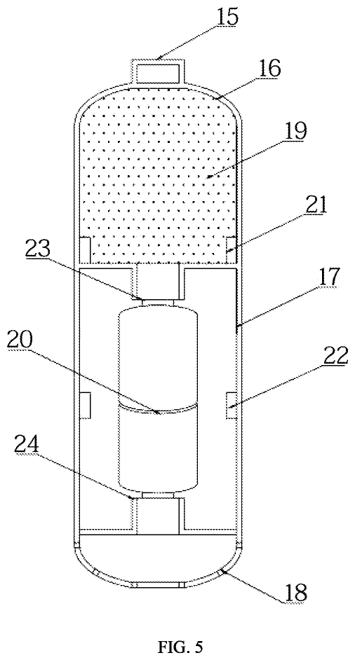

As shown in FIGS. 1-5, an apparatus and a method for preparing hydrogen water are provided. The apparatus includes a pressure tank 1 made of stainless steel, a membrane-type liner 2, a pressure tank cover 3 made of stainless steel and a multifunctional water processor 25, where the membrane-type liner 2 and the multifunctional water processor 25 are detachably arranged in the pressure tank 1, and the pressure tank cover 3 is detachably arranged on the pressure tank 1. An interior of the membrane-type liner 2 forms a first cavity 5, and a second cavity 6 is formed between an inner wall of the pressure tank 1 and an outer wall of the membrane-type liner 2. The membrane-type liner 2 is made of silica gel. The pressure tank cover 3 is provided with a first water port 4, and a bottom of the pressure tank 1 is provided with an air hole 7. The pressure tank 1 is sealedly connected with the pressure tank cover 3 through the threaded connection, so that the pressure tank cover 3 can be disassembled quickly, facilitating the cleaning and disinfection of the membrane-type liner 2. An upper convex ring 10 is arranged on an upper surface of an outer wall of an opening of the membrane-type liner 2, and a surface of the pressure tank cover 3 contacting with the upper convex ring 10 is provided with an upper annular groove 12 matching with the upper convex ring 10. A lower convex ring 11 is arranged on a low surface of the outer wall of the opening of the membrane-type liner 2, which matches with a lower annular groove 13 arranged on the opening of the pressure tank 1, such that the pressure tank cover 3 is just arranged above the upper convex ring 10 for sealed connection. The first water port 4 of the pressure tank cover 3 is provided with a quick-plug assembly 9 made of stainless steel, including a female plug 91 and a male plug 92, where the female plug 91 is sealedly connected with the male plug 92 by plugging, which can isolate the air, so that the hydrogen water will not be exposed to the air during the process of inflow and outflow, preventing secondary pollution, and keeping the stored hydrogen water in a fresh state for a long time. Furthermore, the quick-plug assembly 9 can be quickly connected with various drinking water equipment or water supply equipment to realize the integration of utilization, storage and preparation of hydrogen water. In an embodiment shown in FIG. 4, a threaded joint 101 is provided at the first water port 4, where one end of the threaded joint 101 is sealedly connected with the first water port 4 on the pressure tank cover 3, and the other end of the threaded joint 101 is sealedly connected with various drinking water equipment or water supplying equipment by screwing.

The purified water is injected to the multifunctional water processor 25 through the first water port 4, and then enters the first cavity 5 (namely an interior of the membrane-type liner 2 made of silica gel) for storage. The multifunctional water processor 25 includes a first chamber and a second chamber arranged in series. A first functional core 19 arranged in the first chamber is composed of activated carbon fiber and a non-woven material, and a second functional core 20 arranged in the second chamber is composed of two sets of detachable magnetic materials. The above-mentioned two chambers are sealedly connected by threaded connection, and are in communication with each other. A second water port 15 on the multifunctional water processor 25 and the water inlet/outlet 4 on the pressure tank cover 3 are threadedly connected for feeding and discharge of water. Through the multiple excellent functions such as filtration, adsorption, purification, interaction, activation, and energy storage, the multifunctional water processor 25 can effectively promote the disinfection and sterilization, water purification, and improvement of mouth feel, further ensuring the obtained hydrogen water to be clean, safe and healthy. In addition, after the magnetic resonance in the magnetic field, the permeability, solubility and other excellent properties of the water can be further enhanced, so as to further improve the ability to dissolve and stabilize hydrogen molecules. The permeability of the silica gel is 73.8 barrer (1 barrer=10⁻¹⁰·cm³(STP) cm·s⁻¹·cm⁻²·cmHg⁻¹). Since the polymer composite has good elasticity, the pore structure thereof can be stretched by increasing the pressure, improving the permeability and diffusion coefficient of the hydrogen molecules. Ultra pure hydrogen gas (purity: 99.999%) with a pressure of 0.15 MPa was fed into the second cavity 6 through the air hole 7 for storage (for about 3-month use; the hydrogen gas can be repeatedly fed when it is insufficient). The hydrogen gas stored in the second cavity 6 can be diffused into the membrane-type liner 2 for 1 hour, and then gradually penetrates into the water in the first cavity 5. Meanwhile, the pressure tank 1 is placed on an ultrasonic oscillator to accelerate the diffusion of hydrogen molecules and enable the hydrogen molecules and water to be fully mixed. Then the pressure tank 1 is subjected to standing for 2 h to form a stable hydrogen-in-water structure to obtain hydrogen water with a hydrogen molecule concentration of 3.36 ppm. When the first water port 4 is opened, the hydrogen water in the first cavity 5 is driven by the gas pressure in the second cavity 6 to be automatically discharged.

A comparison test is performed between a hydrogen water sample prepared by the commonly-used electrolysis method and a hydrogen water sample prepared by the apparatus provided herein. Specifically, the hydrogen water samples are exposed to the environment air at 20° C., and the content of hydrogen molecules is measured respectively at different time points. The results are shown in Table 1, from which it can be concluded that after exposed for 2 h, the hydrogen water sample prepared herein exhibits a higher hydrogen residual rate, which is 30% higher than that of the sample prepared by the common electrolysis method. It shows that the hydrogen water prepared herein has a superior structural stability.

A cup of the hydrogen water prepared by the apparatus provided herein, which undergoes the treatment of the multifunctional water processor is taken, and determined by 17O-nuclear magnetic resonance spectroscopy (NMR) to have a half-width less than 100 Hz. By comparison, it can be found that the hydrogen content of the hydrogen water undergoing the treatment of the multifunctional water processor is significantly higher than that of the hydrogen water without undergoing the treatment of the multifunctional water processor. At the same time, their hydrogen molecule contents are measured respectively at different time points after exposed to air at 20° C., and the results were shown in Table 1. After the 2-hour exposure, the hydrogen residual rate of the hydrogen water undergoing the treatment of the multifunctional water processor is at least 5% higher than that of the hydrogen water without the treatment of the multifunctional water processor.

TABLE 1
Stability comparison of the hydrogen molecule in the hydrogen water

| | Hydrogen water prepared | | Hydrogen water sample | | Hydrogen water sample | |
|---|---|---|---|---|---|---|
| | by electrolysis | | 1 prepared herein | | 2 prepared herein | |
| | Hydrogen | Hydrogen | Hydrogen | Hydrogen | Hydrogen | Hydrogen |
| Exposure | content | residual rate | content | residual rate | content | residual |
| time | (ppm) | (%) | (ppm) | (%) | (ppm) | rate (%) |
| 0 | 0.638 | 100 | 0.650 | 100 | 0.696 | 100 |
| 0.5 | 0.452 | 70.8 | 0.569 | 87.5 | 0.658 | 94.5 |
| 1 | 0.387 | 60.7 | 0.540 | 83.1 | 0.636 | 91.41 |
| 2 | 0.293 | 46.1 | 0.496 | 76.3 | 0.603 | 86.22 |

Notes:
the hydrogen water sample 1 does not undergo the treatment of the multifunctional water processor;
the hydrogen water sample 2 undergoes the treatment of the multifunctional water processor.

What is claimed is:

1. An apparatus for preparing hydrogen water, comprising:
a pressure tank;
a membrane-type liner;
a pressure tank cover; and
a multifunctional water processor;
wherein the membrane-type liner is made of a functional polymer composite; the membrane-type liner and the multifunctional water processor are detachably arranged in the pressure tank, and the pressure tank cover is detachably arranged on the pressure tank; the pressure tank, the membrane-type liner and the pressure tank are sealedly connected to form two cavities; an interior of the membrane-type liner is configured to be a first cavity for storing water treated by the multifunctional water processor; a second cavity is formed between an inner wall of the pressure tank and an outer wall of the membrane-type liner for storing hydrogen gas; and a permeability of the membrane-type liner is 2-1000 barrer.

2. The apparatus of claim 1, wherein the permeability of the membrane-type liner is 2-300 barrer.

3. The apparatus of claim 1, wherein the membrane-type liner is made of rubber or a thermoplastic elastomer with permeability and elasticity.

4. The apparatus of claim 1, wherein a pressure of the hydrogen gas in the second cavity is 0.01-2 MPa.

5. The apparatus of claim 1, wherein the pressure tank cover is provided with a water port for feeding and discharge of water; and the pressure tank is provided with an air hole.

6. The apparatus of claim 5, wherein a quick-plug assembly is provided at the water port of the pressure tank cover; the quick-plug assembly comprises a female plug and a male plug; one end of the female plug is sealedly connected with the water port on the pressure tank cover; and the other end of the female plug is sealedly connected with the male plug by plugging; or
a threaded joint is provided at the water port; and one end of the threaded joint is sealedly connected with the water port on the pressure tank cover.

7. The apparatus of claim 1, wherein a fastener is arranged on the pressure tank; the pressure tank is sealedly connected with the pressure tank cover through the fastener; or
the pressure tank is threadedly connected with the pressure tank cover.

8. The apparatus of claim 1, wherein a surface of the membrane-type liner sealedly connected with the pressure tank cover is provided with an upper convex ring; a surface of the pressure tank cover in contact with the upper convex ring is provided with an upper annular groove matching with the upper convex ring; and a surface of the membrane-type liner sealedly connected with the pressure tank is provided with a lower convex ring; and a surface of the pressure tank in contact with the lower convex ring is provided with a lower annular groove matching with the lower convex ring.

9. The apparatus of claim 1, wherein the multifunctional water processor comprises at least one chamber arranged in series; each of the at least one chamber is provided with a replaceable functional core; and the functional core in at least one of the at least one chamber is made of a magnetic material; the at least one chamber is sealedly connected through a thread connection or a quick-plug joint; and the at least one chamber is in communication with each other; and the water port on the pressure tank cover is sealedly connected to a water port on the multifunctional water processor through threaded connection or quick plugging.

10. A method for preparing hydrogen water using the apparatus of claim 1, comprising:
injecting purified water into the first cavity of the pressure tank;
feeding hydrogen gas into the second cavity; and
diffusing the hydrogen gas stored in the second cavity into the membrane-type liner followed by penetration into the water in the first cavity to form the hydrogen water with accumulated hydrogen gas molecules.

11. The method of claim 10, comprising:
(1) purifying water in advance to obtain the purified water;
(2) evacuating air in the pressure tank by vacuuming or by hydrogen purging;
(3) injecting the purified water into the first cavity of the pressure tank for storing;
(4) feeding the hydrogen gas into the second cavity for storing, and increasing a pressure in the second cavity to 0.01-2 MPa;
(5) diffusing the hydrogen gas stored in the second cavity into the membrane-type liner followed by penetration into the water in the first cavity; and
(6) subjecting the pressure tank to standing, and adjusting the pressure in the second cavity of the pressure tank to a range for use of the hydrogen water; or
an order of the step (3) and the step (4) is exchanged.

12. The method of claim 10, wherein in step (5), the diffusion of the hydrogen gas into the membrane-type liner is performed by ultrasonic vibration for 0.1-10 h.

13. The method of claim 11, wherein in step (3), prior to the injection to the first cavity of the pressure tank, the purified water is first treated in the multifunctional water processor.
